(19) United States
(12) Patent Application Publication
(10) Pub. No.: US 2026/0329769 A1
(43) Pub. Date: Oct. 22, 2026

(54) PREDICTIVE DATA CACHING AND LATENCY OPTIMIZATION FOR EDGE DEVICES

(71) Applicant: INTERNATIONAL BUSINESS MACHINES CORPORATION, ARMONK, NY (US)

(72) Inventors: Jessica Nahulan, Vaughan (CA); Heather Nicole Polgrean, Lagrangeville, NY (US); Sarbajit Kumar Rakshit, Kolkata (IN); Carolina Garcia Delgado, Zapopan (MX)

(21) Appl. No.: 19/182,945

(22) Filed: Apr. 18, 2025

(51) Int. Cl. G06F 12/0806

(52) U.S. Cl. CPC G06F 12/0806; G06F 2212/60

(57) ABSTRACT

A method, computer system, and a computer program product for adaptive data caching is provided. The present invention may include generating a digital twin of an optimization target based on a plurality of data, wherein at least a portion of the plurality of data is gathered by directing one or more Internet of Things (IoT) devices to perform specific sensor readings. The present invention may include performing a plurality of simulations using the digital twin, wherein the plurality of simulations are utilized to predict data usage scenarios of the optimization target. The present invention may include generating a plurality of caches based on the predicted data usage scenarios of the optimization target. The present invention may include deploying a plurality of caches on one or more edge devices.

### BACKGROUND

The present invention relates generally to the field of computing, and more particularly to data caching and optimization.

In various industries, real-time data processing may be very much dependent on a combination of at least streaming and edge computing. Managing of data flow and cache on edge devices requires predictive planning for future network conditions and latency spikes. How the data flow is managed may result in, for example, inefficient data caching, excessive energy consumption, and unfavorable operational and performance analysis, these data flow management issues can be further exacerbated in dynamic or high variation environments which may result in delayed decision making on critical issues.

### SUMMARY

Embodiments of the present invention disclose a method, computer system, and a computer program product for data caching optimization. The present invention may include generating a digital twin of an optimization target based on a plurality of data, wherein at least a portion of the plurality of data is gathered by directing one or more Internet of Things (IoT) devices to perform specific sensor readings. The present invention may include performing a plurality of simulations using the digital twin, wherein the plurality of simulations are utilized to predict data usage scenarios of the optimization target. The present invention may include generating a plurality of caches based on the predicted data usage scenarios of the optimization target. The present invention may include deploying a plurality of caches on one or more edge devices.

In another embodiment, the method may include adjusting cache refresh intervals for at least one or more of the plurality of caches based on a real time latency analysis.

In another embodiment, the method may include identifying a specific activity area of the optimization target based on the plurality of simulations performed using the digital twin; reallocating at least a portion of a plurality of IoT devices of the optimization target to the specific activity area; directing the portion of the plurality of IoT devices to perform specific sensor readings of the specific activity area; and performing additional simulations using the digital twin and data received from the specific sensor readings.

In a further embodiment, the method may include ranking data caching priority for each of the plurality of caches based on real-time environmental and operational data.

In yet another embodiment, the method may include recommending at least two or more newly identified edge resource options from a combination of co-location and static edge sites based on user specific priorities,

In addition to a method, additional embodiments are directed to a computer system and a computer program product for data caching and latency optimization by using digital twin simulation to predict future data usage scenarios and proactively allocate advanced caches based on the predicted future data usage on edge devices. The at least two or more newly identified edge resource options are displayed to a user in a data allocation user interface, wherein the display includes improvement metrics overlayed on the display for each of the at least two or more newly identified edge resource options.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 depicts a block diagram of an exemplary computing environment according to at least one embodiment; and

FIG. 2 is an operational flowchart illustrating a process for data caching according to at least one embodiment.

### DETAILED DESCRIPTION

The following described exemplary embodiments provide a system, method, and program product for data caching. As such, the present embodiment has the capacity to improve the technical field of data caching and latency optimization by utilizing digital twin simulations for predictive data caching and latency optimization for edge devices. More specifically, the present invention may include generating a digital twin of an optimization target based on a plurality of data, wherein at least a portion of the plurality of data is gathered by directing one or more Internet of Things (IoT) devices to perform specific sensor readings. The present invention may include performing a plurality of simulations using the digital twin, wherein the plurality of simulations are utilized to predict data usage scenarios of the optimization target. The present invention may include generating a plurality of caches based on the predicted data usage scenarios of the optimization target. The present invention may include deploying a plurality of caches on one or more edge devices.

As described previously, in various industries, real-time data processing may be very much dependent on a combination of at least streaming and edge computing. Managing of data flow and cache on edge devices requires predictive planning for future network conditions and latency spikes. How the data flow is managed may result in, for example, inefficient data caching, excessive energy consumption, and unfavorable operational and performance analysis, these data flow management issues can be further exacerbated in dynamic or high variation environments which may result in delayed decision making on critical issues.

Therefore, it may be advantageous to, among other things, generate a digital twin of an optimization target based on a plurality of data, wherein at least a portion of the plurality of data s gathered by directing one or more IoT devices to perform specific sensor readings, perform a plurality of simulations using the digital twin, wherein the plurality of simulations are utilized to predict data usage scenarios of the optimization target, generate a plurality of caches based on the predicted data usage scenarios of the optimization target, and deploy the plurality of caches on one or more edge devices.

According to at least one embodiment, the present invention may improve data caching and latency optimization by predicting future data usage scenarios using digital twin simulations and proactively allocating advanced caches on edge devices based on the predicted scenarios for which data caching is required.

According to at least one embodiment, the present invention may improve data caching and latency optimization by analyzing the type and nature of data and information which are to be cached from remote systems, then determining optimal cache generations, refreshing timing and frequency of the refresh based on at least predicted latency.

According to at least one embodiment, the present invention may improve data caching and latency optimization by generating advanced caches for the predicted usage, using Generative Artificial Intelligence (GenAI) to deploy the advanced caches on edge devices in advance to minimize latency and optimize data flow.

According to at least one embodiment, the present invention may improve data caching and latency optimization by dynamically adjusting cache refresh intervals based on real-time latency analysis and continuously monitoring network conditions to avoid redundant updated while ensuring cache freshness.

According to at least one embodiment, the present invention may improve data caching and latency optimization by ranking data caching priority based on real-time environmental and operational data, continuously simulating dynamic conditions using digital twin simulations to adapt cache hierarchies ensuring optimal cache allocation.

According to at least one embodiment, the present invention may improve data caching and latency optimization by controlling cache refresh on edge devices to optimize energy consumption by strategically identifying cache refresh cycles based on predicted latency spikes and network stability while dynamically balancing latency reduction and energy efficiency.

According to at least one embodiment, the present invention may improve data caching and latency optimization by recommending potential data resource sites, including those not currently available to the end user associated with the optimization target by simulating cost requirements with the target of cost efficiency and/or other factors derived from the user specific priorities. These potential data resource sites and associated improvement metrics being presented to the user within a data allocation user interface that allows the user to interact with specific recommendations and evaluate their implementations. The implemented recommendations being leveraged to training one or more reinforcement learning models to provide more specific user recommendations in the future.

According to at least one embodiment, the present invention may improve data caching and latency optimization over the prior art by going beyond optimizing cache hit rates by using digital twin simulations to predict and manage real-time data flow and system performance in edge computing environments. The prior art uses digital twins for reinforcement learning and predictive evaluation of cache replacement policies. Our system offers a holistic optimization of network performance with a comprehensive approach for future demands, which takes into consideration factors such as energy efficiency and sustainability. Additionally, our system emphasizes proactive cache deployments based on anticipated data demand spikes, not just based on current conditions, and is able to handle potential bottlenecks before they occur.

According to at least one embodiment, the present invention may improve data caching and latency optimization over the prior art by going beyond just focusing on enhancing server caching and instead focusing on proactive cache prediction and deployment using digital twin simulations integrated with real-time IoT data and operational context. Additionally, it emphasizes adaptability across diverse scenarios, considers energy and sustainability optimizations, and offers holistic performance optimization, extending its applicability beyond just manufacturing factories.

According to at least one embodiment, the present invention may improve data caching and latency optimization over the prior art by going beyond the focus of on adaptive caching using machine learning algorithms to prefetch and optimize cache placement based on network conditions and content popularity, prioritizing cache hit rates and instead using digital twin simulations to predict future data usage scenarios and proactively allocate caches using real-time operational data, while also emphasizing energy-efficient management, dynamic refresh intervals, and broader adaptability across diverse contexts. Whilst considering potential resource allocation site options and modifications to the organizations network architecture to optimize performance.

According to at least one embodiment, the present invention may improve data caching and latency optimization by considering digital twin simulations to predict future data usage scenarios and will proactively be allocating advanced caches based on the predicted scenario on edge devices, the present invention will be analyzing the type and nature of data from remote systems which are to be cached, and then based on predicted latency, cache generation and refresh timing and frequency, the proposed system will determine the optimum future time line for advance cache creation with digital twin simulation, and will be deployed on edge servers. Based on the identified time in advance and the types of data and information are to be cached for any predicted scenario, the present invention will use digital twin simulation to analyze future conditions, and accordingly with GenAI, the proposed system will generate advanced caches, which will be deployed on edge servers to minimize latency and optimize data flow to enhance real-time responsiveness and improves overall cache management efficiency.

According to at least one embodiment, the present invention may improve data caching and latency optimization by performing adaptive cache management by dynamically adjusting cache refresh intervals based on real-time latency analysis between edge devices and remote servers, and with a continuous feedback mechanism, the proposed system will monitors network conditions and optimizes caching decisions to avoid redundant updates while ensuring cache freshness, and accordingly with the adaptive mechanism the present invention will enhance overall computational efficiency by cache refresh timing to current latency patterns for dynamic network environments.

According to at least one embodiment, the present invention may improve data caching and latency optimization by dynamically rank data caching priority based on detected context, the present invention will be assessing real-time environmental and operational data to prioritize critical information for advanced caching and accordingly adapts cache hierarchies based on predicted usage patterns and real-time context. The present invention will be considering digital twin simulation to continuously simulates and evaluates dynamic conditions, ensuring optimal cache allocation and seamless data flow for edge caching efficiency, minimizes latency.

According to at least one embodiment, the present invention may improve data caching and latency optimization by controlling cache refresh on the edge devices by optimizing overall energy consumption by strategically identifying the timing for cache refresh cycles based on predicted latency spikes and network stability. The present invention will dynamically adjust refresh intervals to create an optimal balance between minimizing latency and maximizing energy efficiency and ensures that cache refreshes occur only when necessary, reducing unnecessary energy expenditure while maintaining low-latency data access and ensure overall system performance and sustainability.

According to at least one embodiment, the present invention may improve data caching and latency optimization by assessing and recommending optimal edge resource options, focusing on enhancing network performance through strategic use of available infrastructure. The present invention will additionally evaluate potential new sites, employing advanced simulations to predict how different edge configurations could improve latency and operational efficiency. The present invention will output a comprehensive analysis of cost implications, including setup and maintenance, rental and subscription costs. Available infrastructure providers and collaboration options will be evaluated to optimize resource usage and suggest a mix of co-location and resource sharing options, to facilitate a cost-efficient network architecture optimizing the placement of edge resource utilization.

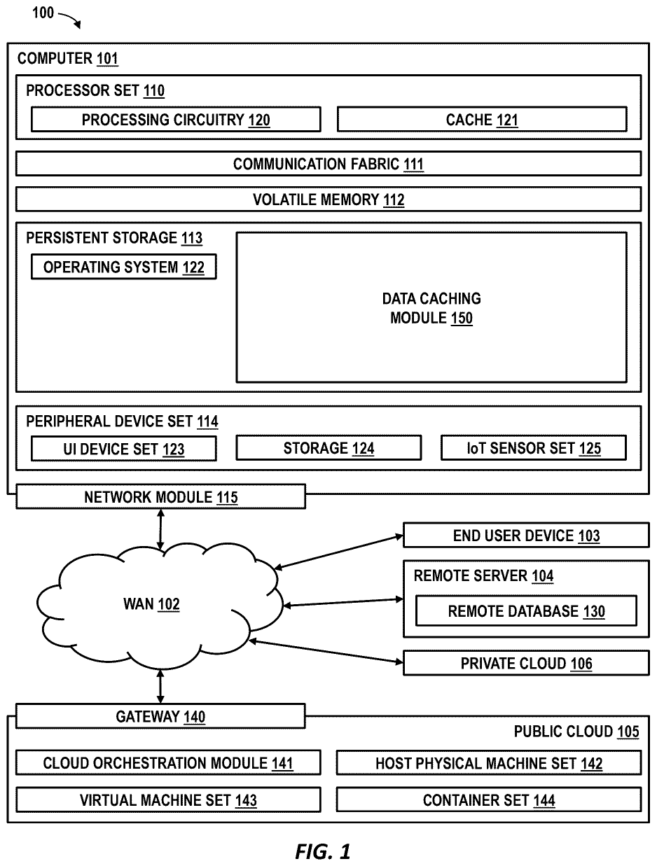

Referring to FIG. 1, Computing environment 100 contains an example of an environment for the execution of at least some of the computer code involved in performing the inventive methods, such as using digital twin simulation to predict future data usage scenarios and proactively allocate advanced caches based on the predicted future data usage on edge devices by data caching module 150. In addition to module 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and module 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor Set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in module 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent Storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in module 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

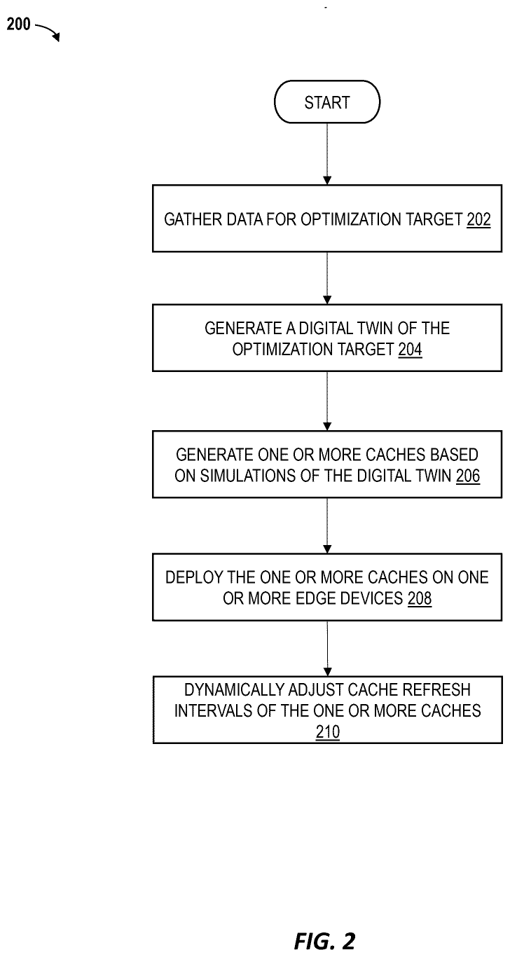

According to the present embodiment, the computer environment 100 may use the data caching module 150 to use digital twin simulations to predict future data usage scenarios and proactively allocate advanced caches based on the predicted future data usage on edge devices by data caching module. The predictive data caching and latency optimization method is explained in more detail below with respect to FIG. 2.

Referring now to FIG. 2, an operational flowchart illustrating the exemplary data caching process 200 used by the data caching module 150 according to at least one embodiment is depicted.

At 202, the data caching module 150 gathers data for an optimization target. The data caching module 150 may gather historical data for an optimization target. The data caching module 150 may gather the historical data either directly by requesting specific data and/or directing data readings to be performed using controlled devices associated with the optimization target or indirectly by receiving from a user. The historical data may be received, identified, and/or uploaded by the user of the data caching module 150 within a data allocation user interface (e.g., user interface). The data caching module 150 may display the data allocation user interface (e.g., user interface) to the user in at least, an internet browser, dedicated software application, and/or as an integration with a third-party software application. The data allocation user interface (e.g., user interface) may be part of the UI device set 123 and accessed by the user utilizing ne or more of the EUDs 103. The data may be received, identified, and/or uploaded by the user within the user interface and/or received from one or more Internet of Things (IoT) devices within the IoT sensor set 125 that may be associated with the optimization target.

Additionally, in embodiments in which the user directly uploads the historical data to the data allocation user interface (e.g., user interface), the data caching module 150 may automatically identify additional data which may be required for the data caching process 200 and/or the digital twin simulations, which will be described in further detail below. In these embodiments, the data caching module 150 may directly request additional data from the one or more IoT deices associated with the optimization target and/or direct the one or more IoT devices associated with the optimization target to perform additional readings and/or gather additional data which may be required for predicting future data usage scenarios and/or allocating caches on edge devices. The data caching module 150 may store the historical data and additional data gathered in response to the commands sent to the one or more IoT devices in a knowledge corpus (e.g., database 130). The optimization target may be comprised of a plurality of edge devices which may collect data from various source, perform initial processing, and transmit data to a central server or cloud for further analysis or store. These edge devices may include, but are not limited to including, sensors, gateways, routers, smart cameras, industrial PCs, autonomous vehicles, amongst other IoT devices.

The user may also provide internal documentation, business processes, electricity bills, current edge service provider agreements, workflow documentation, amongst other information within the data allocation user interface (e.g., user interface) such that the data caching module 150 can identify workflows performed by the optimization target or specific workflows performed in specific activity areas as well as the steps and data usage associated with each of the steps and activities comprising those steps. The user may also identify critical steps or activities within the workflows identified within the data allocation user interface (e.g., user interface) such that the user may specify a particular step or activity for which they want to reduce latency, improve network performance, or even enhance data privacy. For example, the data caching module 150 can process specific data locally to increase data privacy by reducing an amount of data that needs to be transmitted over the network. The data caching module 150 may utilize the information above in conjunction with data related to budgets, goals, and metric thresholds in identifying user specific priorities which as will be described in detail below may influence the data caching process 200 such that it is specifically tailored to the user along with the recommendations provided to the user at step 210 including the optimal edge resource sites identified and the new edge resource options recommended.

The optimization target may be any entity running one or more applications with different levels of latency. The computer architecture may include a broad spectrum of potential locations in which these one or more application could run, and which applications should be optimized to run at which optimal locations. Accordingly, the network edge may be the resources for storage and/or compute proximal to an end user within the telecoms network. For example, the data caching module 150 may leverage the digital twin simulations described below to identify what types of data and information are to be considered for analysis. In the case where an optimization target may be an oil or gas producer these considerations may include, corrosion monitoring data from pipelines, flow rates, pressure, and temperature from refining units, gas leak detection and emission monitoring, fire, and explosion risk data, amongst other examples. As will be explained in more detail below, the data caching module 150 will utilize the digital twin simulations to identify which of these contextual scenarios are to be cached in the edge devices proactively, before a corresponding scenario arises.

Continuing with the above example the data caching module 150 may generate a digital twin model of the activity area and/or optimization target identified by the user within the data allocation user interface (e.g., user interface). The activity area and/or optimization target may be integrated with various Internet of Things (IoT) sensors, such as, in this example, corrosion monitoring devices, flow rate devices, thermometers and/or other temperature devices, gas leak detectors, fire detectors, accelerometers for measuring vibration, amongst other IoT devices which may be specific to the activity area and/or optimization target. Additionally, the data caching module 150 may also receive activity-specific parameters, such as spatial limits, workflows performed in the activity area, and/or user interactions received from activity specifications. As detailed above, the user may provide any additional historical data input to the data allocation user interface (e.g., user interface) relevant to the activity area and/or optimization target which may vary by industry, activity performed, and/or data optimization goals. As the activity area and/or optimization target is being operated the data caching module 150 may continuously receive real time data and/or additional data by directing the one or more IoT devices to gather specific data/perform specific sensor readings for generating the digital twin.

Another example of an optimization target may be an industrial floor comprised of a plurality of IoT devices and/or other multi-sensor data controllers/receivers, including, but not limited to including, heating and cooling equipment, environmental control equipment, secondary electromagnetic component deployment equipment, robotic systems, automated machines, non-automated machines, equipment controlled by a coordinated control system or the data caching module 150, motorized rails, a conveyor system, wiring, lighting, electronic forges, vehicles, transportation mechanisms, thermostats, lighting, air quality, smoke detectors, carbon monoxide detectors, irrigations systems, security, air conditioning, movement, ventilation systems, or any combination thereof that may be used in a manufacturing, fabrication, assembly, and/or other process that me performed on an industrial floor. Additionally, one or more of the plurality of IoT devices may be connected to or equipped with one or more sensors (e.g., temperature sensor, motion sensor, humidity sensor, pressure sensor, proximity sensor, level sensor, accelerometers, gyroscope, gas sensor, infrared sensor, optical sensor, multi-purpose IoT sensor, among other sensors) to perform readings or control the optimization target. The optimization target may be related to manufacturing, healthcare, aerospace, a smart city, telecommunication provider, cloud service provider, and accordingly the IoT devices and other edge devices associated with the optimization target may vary. The above examples are not mean to be seen as limiting on the scope of the present invention.

The one or more IoT devices described above may just be a portion of the plurality of edge devices utilized by the data caching module 150. In addition to the one or more IoT devices described above, the edge devices may include, sensors, gateways, routers, smart cameras, industrial PCs, autonomous vehicles, as well as intelligent edge devices which may include built-in processors for performing advanced tasks. As will be explained in more detail below, the plurality of edge devices associated with the optimization target and/or activity area enable the data caching module to process data closer to the source and minimize delays for crucial real time applications. Furthermore, the data caching module 150 reduces the volume of data that needs to be transmitted to central servers, reducing bandwidth usage and costs.

As will be detailed further below, the digital twin may be utilized by the data caching module 150 to simulate and identify environmental impacts and/or identify critical scenarios for which real-time responsiveness is required. Additionally, based on the context of the edge computing and the need of appropriate types of data and network latency, the data caching module 150 may determine an optimal cache deployment strategy based on the digital twin simulations, here, the data is classified based on access frequency and latency sensitivity. The data caching module 150 may continuously receive real time data and/or additional data by directing the one or more IoT devices to gather specific data/perform specific sensor readings for updating/generating the digital twin of the optimization target.

At 204, the data caching module 150 generates a digital twin of the optimization target. The data caching module 150 may generate the digital twin of the optimization target based on the historical data and/or additional data gathered by the data caching module 150 at step 202 as well as any other data which may be stored in the knowledge corpus (e.g., database 130).

The digital twin may be a virtual representation of an object or system that spans the object or system's lifecycle, and may be updated using real-time data, and may utilize at least, simulation, machine learning, and/or reasoning in aiding informed decision making. The data caching module 150, may utilize the digital twin in aiding informed decision making with respect to future data usage scenarios of the optimization target using predictions generated as a result of a plurality of simulations performed.

The data caching module 150 may utilize the digital twin of the optimization target to predict future data usage scenarios based on a plurality of simulations performed. The data caching module 150 may utilize the digital twin of the optimization target and/or a specific area within the optimization target identified by the user within the data allocation user interface (e.g., user interface) to predict future data usage scenarios based on the plurality of simulations performed. The plurality of simulation performed by the data caching module 150 may employ, but are not limited to employing, dynamic input integration, simulation mechanics, and scenario generation.

The dynamic input integration may include, but is not limited to including, real-time sensor feeds, for example, IoT device telemetry samples at 10-500 millisecond (ms) intervals via Message Queuing Telemetry Transport (MQTT) and/or Constrained Application Protocol (CoAp), and historical data, including for example, but not limited to, cache hit/miss ratios, latency distributions stored in time-series databases. Additionally, the dynamic input integration may further include network condition parameters as well as contextual meta data. The network condition parameters may include, but are not limited to including, packet loss rates, bandwidth utilization thresholds, jitter metrics, amongst other network condition parameters that may collected via Simple Network Management Protocol (SNMP), NetFlow, and/or various other network monitoring protocols. The contextual meta data may include, but are not limited to including, edge device compute capacity, energy constraints, application service-level agreements (SLAs), amongst other contextual metadata.

The simulation mechanics and/or mechanisms which may be employed by the data caching module 150 may include, but are not limited to including, discrete-event simulation (DES) modeling, Monte Carlo stochastic modeling, Long Short-Term Memory (LSTM) neural networks, amongst other machine learning models, simulations mechanics and/or mechanisms which may be employed by the data caching module 150. The DES modeling data may handle requests as a Poisson process, weighting by priority levels. For example, critical sensor data may have a latency tolerance of μ=50 ms versus the latency tolerance for which may be batch logs: μ=2 s. The Monte Carlo stochastic modeling may be employed by the data caching module 150 for a plurality of forecasting scenarios, for example, the data caching module 150 may utilize the Monte Carlo simulations for forecasting latency spikes of the 99^{th} percentile under variable load, such as, but not limited to 20-100% of network utilization. The LSTM neural networks which may be employed by the data caching module 150 may employ various architectures and will be explained in further detail below. For example, the data caching module 150 may employ a LSTM neural network with a three-layer architecture and 128 hidden units in at least one embodiment, in this embodiment the LSTM neural network may be trained on historical access patterns and utilized to predict demand surges, for example, with +/−7% error tolerance over 1-hour horizons.

For scenario generation, the data caching module 150 may model a plurality of scenarios, including but not limited to including, stress-test scenarios, proactive cache maps, energy-aware refresh schedules, amongst other scenarios. For example, stress test scenarios may include 10-fold increase in traffic spikes and/or node failures to validate cache resilience. In another example, proactive cache maps may include specifying pre-deployed data chunks, such as, but not limited to Redis key-value pairs, on prioritized edge nodes, such as devices with greater than 8 gigabytes of RAM. In yet another example, the energy-aware refresh schedules may be optimized via quadratic programming to balance latency, for example, less than 100 milliseconds for 95% of requests and power consumption, less than 5 watts per edge device.

The data caching module 150 may analyze cache utilization parameters (i.e., hit ratios, eviction rates) and validity of historical data, which may be verified via Kolmogrov-Smirnov tests for distribution alignment, to generate the plurality of caches for different future scenarios as identified as part of the plurality of simulations. For example, high-risk scenarios (i.e., predicted equipment failure) triggering pre-caching of diagnostic datasets (i.e., 50 MB fault logs) on redundant edge nodes. Or routine scenarios (i.e., shift changes in industrial settings) where smaller caches need to be deployed (i.e., 5 MB workflow templates) with relaxed refreshed intervals (i.e., 60 seconds or longer).

The data caching module 150 may analyze cache utilization parameters and validity of historical data and other/additional data received at step 202 and the data caching module 150 may perform the digital twin simulation to generate plurality of caches for different possible future scenarios identified in the plurality of simulations such that the data caching module 150 may proactively allocate caches on edge devices based on the data usage scenarios predicted as a result of the plurality of simulations performed using the digital twin. The digital twin may be continuously updated by the data caching module 150 based one real-time sensor feeds, which may ensure that the predictive accuracy of the simulations aligns with the latest environmental and operational conditions. The digital twin may be continuously updated by the data caching module 150 using a sliding window mechanism (i.e., 5-minute epochs) that ingests real-time sensor feeds (i.e., 10,000+ data points/second from unified architecture devices) and validates simulation accuracy by one or more methods, which may include, but are not limited to including statistical divergence checks. For example, Kullback-Liebler divergence equal to or below a predefined threshold for the predicted versus observed latency distributions. Accordingly, this may enable the data caching module to ensure alignment with the latest environmental and operational conditions.

In at least one embodiment, the data caching module 150 will leverage one or more machine learning models, such as, but not limited to, Discrete-event simulation (DES), Monte Carlo stochastic modeling, and/or Long Short-Term Memory (LSTM) networks, which may be trained on the historical data and/or other/additional data gathered at step 202 such that historical access patterns are incorporated in the plurality of simulations allowing the data caching module 150 to identify repeating data usage trends for cache optimization. Additionally, the data caching module 150 may improve the accuracy of the plurality of simulations by comparing the predicted latency metrics versus the actual latency metrics, which may enable the data caching module 150 to adjust future cache placements dynamically based on deviations. The LSTM model may may be trained based on the data gathered at step 202 including time-series historical data, including, but not limited to including, cache access logs, latency metrics, network bandwidth, amongst other time-series data which may be normalized via z-score standardization or min-max scaling to ensure stable conversion. The data caching module 150 may additionally utilize one or more loss functions, regression tasks, classification tasks, optimizers, amongst other tools on the input data. For example, the regression tasks may include, latency prediction, Mean Squared Error (MSE) or Huber loss (i.e., robust to outliers). The classification tasks may include anomaly detection via categorical cross-entropy with class weighting to handle imbalanced data. The data caching module 150 may also combine adaptive learning rates with decoupled weight decay to prevent overfitting and use Nesterov Momentum gradient descent for small input data datasets to avoid noisy gradient updates.

For LSTM model optimization the data caching module 150 may utilize hyperparameter tuning, such as, Bayesian optimization to select optimal sequence length (i.e., 60 timesteps) and hidden layer size (i.e., 128 units) and optimize the learning decay rate, such that, for example, it may be reduced by 50% after 10 epochs of plateaued validation loss. The data caching module 150 may apply spatial dropout to the LSTM outputs to prevent co-adaptation and early stopping to halt training if validation loss does not improve for a specified number of epochs. Additionally, the data caching module may utilize quantization-aware training during backward passes for seamless deployment and pruning at an iterative magnitude which removes less than a certain percentage of weights with minimal impact on accuracy. The LSTM may also be continuously updated by the data caching module 150 using incremental updates via mini-batch SGD on streaming data to adapt to concept drift, such as, but not limited to, seasonal workload shifts. The data caching module 150 may also utilize transfer learning, such that the LSTM may be pre-trained on generic industrial datasets then fine tuned with target-specific sensor logs of the optimization target.

In addition to the models discussed above the data caching module 150 may leverage additional models to predict data usage and optimize caching including, but not limited to including, Gated Recurrent Units (GRUs), Transformer Models, Hybrid Architectures, Lightweight Models for Edge Deployment, amongst other time-series forecasting and sequence modeling techniques which may be utilized. The GRUs being similar to LSTMs but with fewer parameters and faster training. LSTMs are used for analyzing the temporal behavioral data to predict future workloads, like historical workload patterns, cache hit/miss logs, user access time sequences etc. It will identify next workload patterns or optimal cache configurations. For Optimization, the Loss Functions can be Mean Squared Error (MSE) or Mean Absolute Error (MAE) for regression tasks and it can use grid search or Bayesian optimization for tuning learning rate, hidden layers, etc., as will be explained in greater detail below.

The advantages of using the GRUs may include the reduced computational complexity, fewer parameters than the LSTM, for edge devices with limited resources. This may be particular useful in cases prioritizing low-latency predictions in energy constrained environments, such as solar powered IoT sensors. For example, GRUs may be utilized to predict hourly caching demand for non-critical logs, such as environmental telemetry. The advantages of using the transformer models may include the self-attention mechanisms that capture long range dependencies in sparse or irregularly sampled IoT data which may be utilized in multi-modal data fusion, such as, correlating video feeds from edge cameras with vibration sensor logs. For example, a transformed with a four attention heads processes 10,000+ data points/second to forecast latency spikes during peak production shifts. The advantages of the hybrid architecture that may be utilized by the data caching module 150 may combine the temporal modeling of the LSTM with cross-sensor correlation (i.e., transformer) for complex scenarios such as, but not limited to, predicting cache requirements for autonomous vehicles in dynamic environments. For example, the data caching module 150 may utilize the LSTM layers to process time series GPS data while the transformer layers analyze real-time obstacle detection feeds. The data caching module 150 may also deploy lightweight models for edge deployment which may utilize temporal convolutional networks (TCNs) with parallelizable convolutions for low-latency inference. The LSTM/GRU/Transformer predictions feed into Monte Carlo simulations to generate probabilistic cache allocation maps (e.g., 90% confidence intervals). Models may be optimized using Pareto frontiers to balance cache refresh frequency (energy) versus SLA compliance (latency). Deployed models may be A/B tested against rule-based caching (e.g., LRU policies) to quantify improvements (e.g., 40% latency reduction in smart factories).

The digital twins of the optimization target and/or activity area may additionally include integrated real-world congestion data which may be utilized by the data caching module 150 in predicting bandwidth fluctuations which may impact cache refresh intervals. For example, package loss rates, current bandwidth availability, latency fluctuations, traffic spikes based on load, amongst other data may impact decision making. For example, a heavily congested network may mean that refreshing the cache too frequently could adversely affect latency and slow down other critical operations, accordingly in this example the data caching module 150 may reduce the frequency of refresh. More specifically, in an industrial environment receiving thousands of IoT sensor readings to an edge device, the data caching module 150 can pause or slow down cache refresh rates at peak hours to improve the system performance. The data caching module 150 may be capable of caching for overall system performance, multiple IoT devices where caching is orchestrated for overall system priorities, not just for optimization of a single device use. In contrast, if for example, the optimization target is under utilizing the network the data caching module 150 may schedule refreshes more frequently without impacting system performance.

In at least one embodiment, the EUD 103 may be an Augmented Reality (AR) and/or Virtual Reality (VR) enabled device that may enable the user manipulate the digital twin and/or enable the data caching module to overlay information associated with the digital twin to the user, which the user may interact with, such as, but not limited to, input parameters for trial-and-error simulations, projected Key Performance Indicators (KPIs) for the optimization target/activity area before and after cache generation and latency optimization, amongst other information which may be presented to the user within the data allocation user interface (e.g., user interface).

Based on the plurality of simulations performed using the digital twin the data caching module 150 may simulate future data usage scenarios, consider network bandwidth availability, and expected latency. Accordingly, the data caching module 150 may utilize the plurality of simulations performed of future timelines to the generate plurality of caches. As will be explained in greater detail at step 206, the data caching module 150 may generate proactive cache deployment timelines such that the plurality of caches may be deployed based on activity peaks based on the predicted network latency and the volume of data and/or information made available. The data caching module 150 may securely package and transmit the plurality of caches generates using encryption. For example, the data caching module 150 may implement encryption, such as, but not limited to, AES-256 encryption for cache storage and Transport Layer Security (TLS) 1.3 for secure transmission, to prevent unauthorized data interception under zero trust such that only authenticated processes can retrieve and utilize data from the cache.

The data caching module 150 may analyze discrepancies between the predicted data usage patterns of the digital twin simulations and the actual data usage patterns to fine-tune the one or more machine learning models and/or predictive models described above and the digital twin based cache generation described in further detail below, such that the data caching module 150 may improve advanced cache generation over time as the discrepancies are analyzed and models are continuously fine-tuned.

At 206, the data caching module 150 generates the plurality of caches based on the data usage scenarios predicted as a result of the plurality of simulations performed using the digital twin. The plurality of caches may be a temporary storage area for the data associated with the data usage predictions resulting from the plurality of simulations, such that the data caching module 150 may prioritize the storage and quick access to the data most critical to the optimization target while improving application and overall system performance. Details with respect to the plurality of caches will be described in further detail below, as well as additional details regarding the deployment of the plurality of caches, the dynamic adjustment of cache refresh intervals, and ranking of the data caching priority, which will be described in detail at steps 208 and 210.

The data caching module 150 may analyze the types and nature of data to be cached from remote systems prior to generating the plurality of caches in order to determine optimal cache generation. The data caching module 150 may refresh timing and frequency based on predicted latency in order to generate the plurality of caches for the data usage scenarios predicted as a result of the plurality of simulations performed using the digital twin. Additionally, the plurality of caches and storage locations may be based on the data demand, priority, cost of resource site, deployment timelines, amongst other factors that the data caching module 150 may consider. The data caching module 150 may further evaluate the existing potential edge sites according to user proximity, performance improvements, infrastructure capabilities to ensure optimal placement and performance.

As described in detail at step 204, the data caching module 150 utilizes one or more historical learning models to predict the behavior and the context associated with each of the plurality of activities performed as part of a workflow within the optimization target and as result of the plurality of digital twin simulations performed the data caching module 150 may predict data demand and potential bottlenecks enabling advanced cache deployment of the plurality of caches. The data caching module 150 may establish a multi-tier caching structure such that the one or more of the plurality of data caches categorized as high priority based on the plurality of simulations are stored in fast in-memory databases while less frequently access or lower priority data is stored on persistent storage in the edge devices.

The plurality of caches proactively generated by the data caching module 150 may reduce latency and improve responsiveness during critical scenarios identified during the plurality of digital twin simulations. The data caching module 150 may further perform adaptive deployment of the cache while aligning with predicted usage context and network conditions, enabling seamless real-time operations and resource utilization. For example, in real-time industrial monitoring of an optimization target, the data caching module 150 may implement a hybrid caching strategy. This hybrid caching strategy may enable critical abnormalities detected by the digital twin simulations to bypass the cache and be transmitted in real time. It may further enable routine readings not passing abnormality or anomaly thresholds to be cached locals and transmitted in batches to reduce network congestion. Furthermore, the hybrid caching strategy enables historical sensor data to be pre-loaded into the dynamically created cache to enable intelligent trend analysis. This hybrid caching strategy enables the data caching module 150 to ensure no data is lost during disruptions and enhance early warning capabilities without delays, which the data caching module 150 leverages and provides these preemptive warnings to the user within the data allocation user interface (e.g., user interface) and/or as push notification direct alerts to the one or more EUDs 103.

Additionally, in some embodiments, the data caching module 150 may generate the plurality of caches for the predicted data usage using generative artificial intelligence (GenAI). GenAI can be used for generating “smart cache” configurations based on user behavior or predicted workloads, it will consider historical workload data, Data access frequency, Latency patterns, User behavior or usage sequences, Contextual metadata (e.g., time, edge device constraints, priority levels etc. The GenAI models will generate probable cache strategies that align with predicted future usage. Like, which data blocks to cache, their expiry strategy, preloading suggestions IBM® Granite Foundation Models (multimodal, code, language models) may be used, IBM Watsonx.ai® for building and fine-tuning domain-specific GenAI models (IBM, IBM Watson, and all Watson-based trademarks are trademarks or registered trademarks of International Business Machines Corporation in the United States, and/or other countries). The GenAI models described above ingests the following structured and unstructured data to generate optimized caches, including but not limited to including, structured inputs such as historical access patterns, network telemetry, edge device metadata, digital twin outputs, amongst other structured data. This structured data may include time series data detailing cache hit/miss rations, latency distributions, eviction rates, bandwidth utilization, packet loss rates, jitter metrics, compute capacity, energy constraints, simulated scenarios (i.e., Monte Carlo results) predicting demand spikes, failure modes, and/or congestion events amongst other structured data. Unstructured data may include, but are not limited to including, natural language logs, such as, maintenance reports, incident tickets, and/or operator notes, as well as sensor context, including raw text/audio annotations from IoT devices.

Accordingly, the data caching module 150 may utilize the GenAI models described above whereby the data caching module 150 utilizes the GenAI to generate cache pre-fetching logic based on predicted demand. The GenAI being trained on for example, IBM Cloud® logs and RedHat OpenShift® (RedHat and RedHat OpenShift is a registered trademark of RedHat, Inc. in the United States and/or other countries) telemetry for enterprise edge environments. The focus of the data caching module 150 to translate the high-level caching policies into optimized edge code by converting a natural language rule, such as “refresh cache if latency exceeds 100 ms” into a code script. The data caching module 150 may further utilize IBM® Deep Learning Compiler (DLC) to optimize GenAI generated cache policies for specific hardware while using quantization to reduce model footprint for deployment on resource constrained edge nodes. The data caching module 150 may train and fine tune the GenAI using for example, IBM Cloud® Pak for Data, or other data sets as well as industry specific corpora, such as, but not limited to IBM® Maximo Monitor and/or IBM® Edge Application Manager with loss functions such as weighted cross-entropy which penalize mispredictions of critical cache misses and/or reinforcement leaning which may reward the models for reducing SLA violations. The data caching module 150 may also utilize optimizers such as Layer-wise Adaptive Moments (LAMB) and Second-order Stochastic optimization for scalable large batches in distributed edge training and reducing convergence time. The cache's being generated using the GenAI by using scenario embedding from the digital twin simulation outputs, such that they are encoded into dense vectors using for example IBM® Embedding Projector. The structured prompts guiding the GenAI to adhere to different constraints of the optimization target such that the GenAI can generate the cache policy while prioritizing specific data and/or edge devices. The IBM® Granite Foundation Models produce the cache allocation rules and pre-fetch schedules which are compiled using IBM® DLC to compile the riles into edge-optimized binaries. The data caching module 150 may then utilize IBM® Federated Learning and IBM Watson® Open Scale for validation and deployment, whereby the edge nodes collaboratively validate GenAI generated caches via secure aggregation (i.e., homomorphic encryption) without sharing raw data and monitoring the cache performance in production, detecting drift (i.e., rising miss rates) and triggering retraining. While the GenAI implementation described above is described in the context of IBM® products and services, this is not meant to be seen as limiting to the present invention which may utilize various products and services in using GenAI to generate the plurality of predictive caches. The above embodiment allows the pre-training on IBM® specific infrastructure with narrow tailoring for enterprise edge environments and compliance with industry regulations via built in data anonymization. The predicted workload pattern (from LSTM and/or other models described above) may act as a driver for the GenAI model to select what to pre-cache, determine data retention time in cache, Prioritize content delivery to edge devices. The advantages of using GenAI to generate cache strategies based on learned latent patterns, supporting zero-shot and few-shot learning for unseen behavior scenarios, can consider domain constraints like device limitations, time constraints, or task urgency, amongst other domain constraints.

The data caching module 150 may utilize the Gen AI to analyze structured and unstructured data, such as, but not limited to, past access logs, API request orders, amongst other data, to generate cache allocation strategies tailored to predicted workflow patterns. The data caching module 150 may utilize one or more transformed based AI models, fine-tuned for network data, to infer cache pre-fetching requirements from observed data consumption/usage patterns of the optimization target. Additionally, the data caching module 150 may leverage reinforcement learning by employing a feedback loop, such that the data caching module 150 may refine cache generation rules based on actual cache retrieval success rates. The cache will be instantiated using one or more cache services, the one or more cache services may be an in-memory key-value databased which may be utilized as a distributed cache storing directly in RAM such that the one or more cache services utilized by the data caching module 150 may read and write data more efficiently than for example databases relying on disk storage. The data caching module 150 may integrate the new cache node onto the network of the optimization target using the one or more cache services while making it available.

At 208, the data caching module 150 deploys the plurality of generated caches on one or more edge devices. As will be described in more detail below, the smart caches may be generated locally using the GenAI and/or LSTM predictions described above which may then be sent over secure channels with compression and/or encryption depending on edge bandwidth and/or security levels. They may be stored in local cache storage in the knowledge corpus 130 (e.g., database 130) where the metadata is retained, including, for example, timestamp, expiry, priority, amongst other data. In situations of a cache miss, the GenAI may suggest the update of the various cache models of the data caching module 150.

In some embodiments, the generated data caches are securely transmitted to the one or more edge devices using encrypted communication protocols. Prior to transmission by the data caching module 150, each cache may be packaged and serialized in a format optimized for low-latency parsing. At the edge device, the cache may be received by a lightweight cache management service, which may be implemented as a daemon or microservice, responsible for storing the cache in fast-access memory tiers, such as in-memory key-value stores, and tagging each cache with metadata including cache priority, expiration timestamp, and applicable access permissions, amongst other metadata. The plurality of generated caches may be stored either fully in volatile memory for high-speed retrieval or backed by persistent storage depending on their priority classification. During runtime, the edge application stack accesses cached data via an API (Application Programming Interface) layer exposed by the cache manager, enabling low-latency retrieval based on keys, tags, or predicted access sequences. Access patterns may be monitored in real time to update usage metrics, which are used by the digital twin and/or machine learning models to re-prioritize caches dynamically. When cache updates may be required, a differential synchronization method may be employed, where only changed segments of a cache are pushed to the edge device, minimizing bandwidth usage. Furthermore, integrity checks such as hash verification may be performed before a cache is committed to local use, ensuring consistency and tamper protection. The edge cache manager may also include garbage collection logic that purges expired or low-priority caches based on available memory and refresh intervals defined by the cache orchestration policy. In distributed edge environments, a coordination protocol which may be used to synchronize cache refreshes across devices or to promote frequently accessed caches to shared edge layers. On a cache miss, a feedback signal is generated and sent to the GenAI system, which updates its predictive model to improve future cache generation accuracy, enabling implicit self-tuning and continuous cache optimization.

The data caching module 150 may perform adjustments to prediction models, cache generation, and/or deployment policies based on at least, historical learning about advanced cache deployment and effectiveness of edge computing. As will be explained in more detail below, the data caching module 150 may continuously receive, gather, and/or access operational data for the optimization target and/or a specific activity area located within the optimization target throughout the data caching process 200. There data caching module 150 may leverage this continuous operational data for continuous real time digital twin simulations that enable the data caching module 150 to prioritize critical information for caching and accordingly adapt the cache hierarchies dynamically based on continuously updated predicted usage patterns to ensure optimal allocation and seamless data flow. These predicted usage patterns representing ever changing conditions and enhance adaptability for future predictions.

At 210, the data caching module 150 dynamically adjusts cache refresh intervals based on a real time latency analysis. The data caching module 150 may dynamically adjust cache refresh intervals for at least one or more of the plurality of caches based on real time latency analysis and network feedback enabling the optimization of cache refreshes while avoiding redundant updates and enhancing computational efficiency in the network environment of the optimization target and/or activity area. As will be described in greater detail below, the data caching module 150 may optimize cache refresh timing based on at least context, predicted network latency/predicted latency spikes, bandwidth, amongst other network conditions. The data caching module 150 may proactively and dynamically adjust the refresh intervals based on the predicted refresh required for the cache to balance energy consumption with low-latency access, ensuring sustainable system performance of the optimization target and/or activity areas.

The data caching module 150 may include defined operational parameters and metrics for the optimization target and/or activity area. These operational parameters and metrics may be defined by the data caching module 150 in conjunction with input received by the user in the data allocation user interface (e.g., user interface), for example, allowed latency to perform the computation. The data caching module 150 may identify the cache utilization points, such as, but not limited to, edge nodes, and the distributed network parameters, such as, but not limited to, latency, bandwidth, cache freshness, while also considering computational efficiency metrics, such as, but not limited to, CPU usage, memory overhead, and/or cache update frequency to identify how effectively the plurality of caches can be refreshed.

In some embodiments, the data caching module 150 may create a predictive model for dynamic cache adjustments based on historical data on cache usage received at step 202 and continuously received throughout the data caching process 200. Based on the historical data and/or historical learning the predictive model for dynamic cache adjustments may identify optimal cache refresh based on latency, bandwidth, hit rates, and traffic patterns. The predictive model for dynamic cache adjustments may include a cache management layer, the cache management layer may analyze feedback from the cache usage monitoring system and dynamically adjust the cache refresh intervals. The data caching module 150 may utilize the predictive model for dynamic cache adjustments to determine baseline refresh intervals based on the predicted network bandwidth and latency. For example, in increased latency or bandwidth drops, the data caching module 150 may adjust the baseline refresh intervals. If the cache hit rate drops below a threshold or traffic spikes above a threshold, the data caching module 150 may dynamically shorten the baseline refresh intervals.

In at least one embodiment, the predictive model for dynamic cache adjustments is implemented as a machine learning-based forecasting system trained on historical cache telemetry data, which may include, but is not limited to including, historical cache hit/miss rates, edge device memory availability, network latency measures, bandwidth utilization patterns, workload traffic spikes, environmental or operational context. The predictive model may be implemented using a LSTM recurrent neural network architecture due to its ability to model temporal dependencies and recognize repeating patterns in system telemetry. The model is periodically retrained with time-series data to improve its forecasting accuracy. During operation, the predictive model continuously ingests real-time and recent telemetry data and outputs a predicted time-to-staleness (TTS) value for each cache instance. This TTS value represents the estimated duration after which the cache is likely to become outdated or miss-critical based on access frequency, data volatility, and predicted latency behavior. The model may also predict upcoming network degradation windows or latency spikes, based on patterns in congestion, throughput, or maintenance schedules learned from the data.

The cache refresh intervals are then dynamically adjusted by comparing the predicted TTS with current cache validity windows. For example, if the TTS is significantly shorter than the current scheduled refresh interval the cache refresh is pulled forward. In another example, if the predicted latency increases or anomalies are detected, via an isolation forest or DBSCAN model, refreshes may be delayed or prioritized for critical caches only. In yet another example, in high traffic scenarios, refresh scheduling may be delegated to a reinforcement learning agent that explores fresh strategies optimizing a reward function while balancing freshness, bandwidth cost and latency sensitivity.

Additionally, each cache may be annotated with metadata including, but not limited to including, “volatility score,” “access frequency,” and “criticality index.” These scores may be computed by the data caching module 150 via weighted functions during training and used by the model to rank caches and adjust their individual refresh cycles accordingly. For initial model training, labeled datasets can be generated using historical edge activity logs and simulated failure/invalidation scenarios derived from digital twin simulations. Ground truth labels include actual staleness durations, observed cache miss penalties, and downstream latency costs incurred when stale data is served. In some embodiments, these simulations may be accelerated using synthetic time-series generation and bootstrapped with reinforcement learning policies trained in parallel on simulated environments. The data caching module 150 may further optimize redundancy and avoid cache duplication while refreshing the plurality of caches based on the metadata associated with each of the plurality of caches. The data caching module 150 simultaneously will be evaluating the cache freshness and coordinating with the plurality of digital twin simulations for the cache updates. The cache refresh schedule may be dynamically adjusted by the data caching module 150 using at least, but not limited to, weighted exponential moving averages (EMAs) based on network latency and congestion trends. In at least one embodiment, the data caching module 150 may maintain a time-series of observed network latency measurements between the edge device and the central system (e.g., cloud, core network, or backend server). These measurements may be sampled at regular intervals (e.g., every 5 seconds), and an Exponential Moving Average (EMA) is computed to smooth short-term spikes and capture overall network performance trends. Let L(t) be the observed latency at time t. The EMA may be calculated using the formula EMA(t)=α*L(t)+(1−α)*EMA(t−1) where α may be a smoothing factor between 0 and 1. For example, a typical value might be α=0.3 for moderate sensitivity to recent values and the following network latency values in milliseconds were measured at 5 minute intervals. This rolling EMA allows the system to detect gradual increases in latency without reacting too aggressively to single measurement spikes. The data caching module compares the EMA-derived latency trend to a predefined latency threshold (e.g., 130 ms) to decide refresh strategy. If EMA(t) is less than 130 ms, the system extends refresh intervals (e.g., from every 10 minutes to every 20 minutes), reducing bandwidth and energy usage. If EMA(t) is greater than or equal to 130 ms, the system shortens refresh intervals (e.g., down to 5 minutes) to ensure data freshness and mitigate expected access delays. Additionally, the cache manager adjusts the refresh priority queue, so high-EMA zones or caches linked to latency-sensitive operations are updated first. The decision may also incorporate cache “priority score” (e.g., derived from frequency of access or critical system role). The L(t) may be the raw network latency measurement observed at time t, typically between an edge device (e.g., hospital room device hub) and a central data system (e.g., hospital EHR server or cloud-based analytics service). Which may be determined using periodic pings, TCP handshake times, or app-level round-trip measurement and the sampling frequency may be configured depending on how sensitive the application is to latency shifts. The EMA(t−1) may represent the previous EMA value, capturing the smoothed latency trend up to the last interval which provides a historical memory in the trend calculation. While α (alpha) is the smoothing factor, a tunable value between 0 and 1 that may control how much eight is given to recent measurements. A higher α(i.e., 0.8) may enable the model to react quickly to sudden changes which may be utilized by the data caching module 150 for critical systems while a lower α (i.e., 0.2) smooths more heavily which may dampen transient spikes and be utilized by the data caching module 150 for stable workloads. The EMA-based adjustment system may enable dynamic, data-driven cache refresh timing by modeling network latency as a time-weighted trend. The smoothing factor (α) is determined per device type or criticality, and real-time EMA values are compared to predefined latency thresholds to trigger proactive cache updates. This reduces the likelihood of stale data transmission or delayed syncs, especially in environments with intermittent or variable network performance, such as smart hospitals or connected care facilities.

Additionally, the data caching module 150 may utilize one or more anomaly detection models, including, but not limited to including isolation forests to identify unexpected traffic spikes allowing the data caching module 150 to proactively trigger cache updates to prevent latency surges. The data caching module 150 may additionally utilize algorithms such as Support Vector Machine (SVM) and Density-Based Spatial Clustering of Applications with Noise (DBSCAN) in detecting anomalies that may require cache adjustments or updates by the data caching module 150. The data caching module 150 may leverage these anomaly detection models to compare real time data received from, for example, one or more IoT sensor devices associated with the optimization target, with the historical data received at step 202 to detect anomalies within the optimization target data set. In some embodiments, following the detection of an anomaly the data caching module 150 may run specific digital twin simulations to determine the potential impacts of these anomalies on the overall network of the optimization target prior proactively trigger cache updates if the anomaly would not result in a potential latency surge. Additionally, the data caching module 150 may control, reallocate, and direct one or more IoT devices associated with the optimization target to relocate and perform additional sensor readings to confirm the anomaly detected as opposed to a mistake or equipment malfunction. Further details and examples will be described below with respect to the data caching module 150 control of IoT devices associated with the optimization target.

The data caching module 150 may categorize the cache refresh needs for each of the plurality of caches and/or one or more caches into a plurality of categories. In at least one embodiment, the data caching module 150 may categorize the caches into one or three categories, including, but not limited to including, a first high-priority cache, a second medium-priority cache, and a third low-priority cache. The first high-priority cache may include frequently accessed data with latency critical requirements, for example, real-time telemetry data. The second medium-priority cache may include data accessed intermittently but still requiring freshness, for example, user session states. The third low-priority cache, may include data not often accessed or historical data, optimized for energy efficiency. This is only one embodiment, and is not meant to be seen as limiting on the current invention. The data caching module 150 may categorize the cache refresh needs into any number of categories according to any number of metrics or thresholds determined by the data caching module 150 based on the specific requirements of the optimization target and/or activities conducted by the optimization target.

Additionally, the data caching module 150 may perform a ranking of data caching priority for each of the plurality of caches based on real-time environmental and operational data received. The cache deployments may be prioritized by the data caching module based on the criticality of the context for which each of the plurality of caches are generated. The data caching module 150 may determine the criticality of each contextual scenario based on the impact on the overall system of the optimization target and/or activity area in conjunction with the data received at step 202 and/or additional input from the user identifying past operational failures. The high-priority context receiving shorted refresh intervals than low-priority context which are updated less frequently during resource constraints ensuring efficient resource utilization without compromising essential operations.

The ranking of the data caching priority may be presented by the data caching module 150 to the user in the data allocation user interface (e.g., user interface). In these embodiments, the data caching module 150 may utilize various Natural Language Processing (NLP) techniques in generating explanations as to the ranking of the data caching priority. The user may be able to provide feedback as to the raking of the data caching priority within the data allocation user interface (e.g., user interface) which the data caching module 150 may utilize as input in the ranking. Additionally, the data caching module 150 may in response to the user provide the user one or more digital twin simulations based on the predicted outcomes such that the user may visualize using the AR/VR capabilities of the EUD 103 the high-priority context or scenarios and the resource utilization metrics and operational metrics associated with each of the one or more digital simulations.

Additionally, the data caching module 150 may classify the operational data based on if an advanced/prioritized cache may be created while considering the criticality to the system of the optimization target or activity area's performance. The data caching module 150 may use the plurality of digital twin simulations for predictive analysis and ranking of the data caching priority according to predicted future usage needs derived from the plurality of digital twin simulations. The data caching module 150 may further assign a priority score to each data set using a weighted formula, such as, but not limited to, Priority=accessFrequency+latencySensitivity+failureImpact, wherein each of these values are dynamically updated. The data caching module 150 may further utilize the digital twin of the optimization target or activity area to run what-if simulations or scenarios to evaluate an impact of various cache failures or missing caches on the overall system such that the data caching module 150 may ensure high priority data receives preferential cache allocation. The data caching module 150 may further utilize these models to simulate metrics such as cost of data getting delayed, network congestion, latency, amongst other metrics. Additionally, during critical periods or high-priority context, time sensitive caches may be moved to in memory storage and lower priority may be moved to less critical disk-based cache storing with slower access. Furthermore, the data caching module may synchronize the distributed cache instances and ensure balanced workload distribution and consistent cache performance across the network of the optimization target.

In addition to moving high priority and low priority caches the data caching module 150 may also change the data being gathered by the plurality of IoT devices associated with the optimization target. The data caching module 150 may identify what-if scenarios with high impact outcomes and adjust data gathered by multi-purpose IoT devices control specific IoT devices located proximate to an activity area or area of interest allowing the data caching module 150 to actively gather data directly corresponding to the high priority context scenario. These changes, adjustments, or reassignments of priority of IoT devices may be shown in the data allocation user interface (e.g., user interface) coupled with a map of the optimization target or activity area which may include visual indicators providing details to the user corresponding to the changes, adjustments, or reassignments of the IoT devices.

For example, the optimization target may include 100 IoT devices, 10 of which are allocated to an activity area which has been flagged in several of the plurality of simulations conducted using the digital twin. In this example, the data caching module 150 may reallocate one or more of the 90 IoT devices associated with other areas of the optimization target to the activity area and adjust the readings being performed by the one or more reallocated, such as, reassigning a multipurpose IoT sensor that is monitoring a non-critical area by performing humidity readings to the critical activity area to perform temperature readings, such that the data caching module 150 can provide critical data to the digital twin for more accurate simulations to more dynamically rank the data caching priority. In this example, the data caching module 150 may identify the one or more of the IoT devices reallocated to collect data corresponding to the simulation results of the digital twin in the data allocation user interface (e.g., user interface) using visual indicators, such as flags, colors, text boxes, amongst other visual indicators. The multipurpose IoT sensor that was performing humidity readings may be flagged with a temperature icon to indicate that the multipurpose IoT device has been reassigned. The data caching module 150 may return the 100 IoT devices to their original locations, assigned sensor readings, and frequency of those assigned sensor readings following an exceeding of a required data threshold. The required data threshold may be an amount of data or specific readings about an activity area such that the plurality of digital twin simulations includes a confidence metric corresponding to the potential critical risk in the activity area. In this embodiment, although not detailed in this example, the data caching module 150 may utilize the autonomous movement capabilities of any of the IoT devices to move them around the optimization target and/or activity area to gather specific data required for accurate digital twin simulation predictions. This may include, moving or directing specific readings of other IoT devices to fill the knowledge gap from a reallocated IoT device.

The data caching module 150 may improve the accuracy of the plurality of simulations by comparing the predicted latency metrics versus the actual latency metrics, which may enable the data caching module 150 to adjust future cache placements dynamically based on deviations. Additionally, the data caching module 150 may leverage one or more reinforcement learning machine learning models to adjust these future cache placements. The reinforcement learning may be utilized to optimize the plurality of digital twin simulations and/or future simulations based on the comparison of the predicted latency metrics versus the actual latency metrics.

In an embodiment, the data caching module 150 may identify collaboration opportunities between the optimization target and a plurality of infrastructure providers. The data caching module 150 may leverage shared resource to minimize costs and enhance deployment efficiency. The plurality of infrastructure providers and potential sites will be identified for the user in the data allocation user interface (e.g., user interface) based on running current generated optimal workload simulations using the digital twin to predict operational improvements with new identified edge resource options. The data caching module 150 may leverage the AR/VR capabilities of the EUD 103 to display to the user the simulations of operational improvements related to various edge resource options with the information, such as KPI improvement metrics overlayed on the visual display for the user within the data allocation user interface (e.g., user interface). Allowing the user to virtually swipe through different options, mix and match different edge resource options, and easily access the infrastructure providers able to provide the edge resource options directly within the user interface.

The data caching module 150 may further evaluate and recommend optimal edge resource sites through digital twin simulations and collaborative resource sharing to enhance the network performance of the optimization target and/or specific activity area or workflow of the optimization target while reducing costs and ensuring efficient deployment aligned with operational demands and data priorities. The data caching module 150 will assess existing and potential edge resource sites by analyzing a plurality of factors, including, but not limited to including, user proximity, expected performance improvements, and infrastructure capabilities. This evaluation by the data caching module 150 may be based on both historical data demand and real-time data demand as well as cost assessments to ensure optimal placement for enhancing network performance and operational efficiency. The data caching module 150 may utilize Monte Carlo simulation to estimate cost versus latency trade-offs for different edge deployment strategies. Generating a cost impact matrix based on the Monte Carlo simulations which ranks potential edge locations based on setup costs, expected latency improvements, and long-term operational expenses. These simulations and factors considers by the data caching module 150 may be weighted based on user specific priorities related to at least budget, capacity, metric goals or thresholds, amongst other information which may be provided by the user at step 202 and/or updated throughout the data caching process 200 within the data allocation user interface (e.g., user interface).

The plurality of infrastructure providers may be further evaluated by the data caching module 150 using at least k means clustering such that the data caching module 150 may group edge nodes corresponding to the plurality of infrastructure providers based on at least proximity, computing capacity, and existing workload balance. The data caching module 150 may recommend an optimal mix of co-location versus static edge sites while factoring in leasing costs, availability of shared infrastructure, and preferred location sites determined in conjunction with the user specific priorities and other user information received at step 202 and/or throughout the data caching process 200. The data caching module 150 may also generate prompts within the data allocation user interface (e.g., user interface) to gather specific informative information from the user to better recommend the optimal mix of co-location versus static edge sites. As the user interacts with the data allocation user interface (e.g., user interface) the data caching module 150 may utilize a feedback loop to refine future recommendations to the user by one or more reinforcement learning models. This reinforcement learning from human feedback (RLHF) enables the data caching module 150 to understand the user specific priorities beyond what the user might identify and recommend specifically tailored custom improvements to the user that improve over time based on actions taken by the user in response to recommendations and/or feedback directly received in the data allocation user interface (e.g., user interface). In another embodiment, the data caching module 150 may employment other reinforcement learning algorithms in conjunction with or separate from the reinforcement learning described above. In these embodiments, the data caching module 150 may employ reinforcement learning algorithms such as Deep Q-Learning to dynamically optimize resource placement by simulating various configurations and evaluating their performance against real-time and predicted workload data, allowing the data caching module 150 to leverage these reinforcement learning algorithms to iteratively improve decision-making by learning for past deployments and feedback loops.

The data caching module 150 may also generate a comprehensive analysis of costs implications for each of the recommendations or options, including setup and maintenance, rental and subscription expenses for each potential site. This analysis will enable the data caching module to recommend a balanced mix of co-location and resource-sharing options, optimizing the cost-efficiency of edge resource deployment while ensuring scalability. The data caching module 150 may utilize the Generative Artificial Intelligence (GenAI) described above through Large Language Models (LLMs) leveraging Natural Language Processing (NLP) to generate these recommendations, analysis, and other content for the user within the data allocation user interface (e.g., user interface).

The data caching module 150, using the digital twin of the optimization target, may perform simulations to generate an optimal workload model to predict performance improvements at new and existing edge sites. These simulations may account for deployment timeliness, operational constraints, and data demand patterns to ensure reliable and efficient resource placement decisions. As the new edge sites and/or edge resources are acquired the digital twin will be updated to reflect the real world capabilities of the optimization target given the new resources such that the digital twin simulations conducted, the caches generated, and the refresh intervals constantly adapt to the actual capabilities of the optimization target. The data caching module 150 may further utilize multi-objective optimization models, incorporating the constraints such as cost, latency, energy consumption, and deployment timelines provided by the user and/or derived from the user specific priorities to identify the most efficient resource allocation strategies. The data caching module 150 may utilize techniques such as, but not limited to, particle swarm optimization, to ensure scalability and adaptability in diverse network environments.

It may be appreciated that FIG. 2 provides only an illustration of one embodiment and do not imply any limitations with regard to how different embodiments may be implemented. Many modifications to the depicted embodiment(s) may be made based on design and implementation requirements.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of one or more transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

The present disclosure shall not be construed as to violate or encourage the violation of any local, state, federal, or international law with respect to privacy protection.

What is claimed is:

1. A method for adaptive data caching, the method comprising:
generating a digital twin of an optimization target based on a plurality of data, wherein at least a portion of the plurality of data is gathered by directing one or more Internet of Things (IoT) devices to perform specific sensor readings;
performing a plurality of simulations using the digital twin, wherein the plurality of simulations are utilized to predict data usage scenarios of the optimization target;
generating a plurality of caches based on the predicted data usage scenarios of the optimization target; and
deploying the plurality of caches on one or more edge devices.

2. The method of claim 1, further comprising:
adjusting cache refresh intervals for at least one or more of the plurality of caches based on a real time latency analysis.

3. The method of claim 1, further comprising:
ranking data caching priority for each of the plurality of caches based on real-time environmental and operational data.

4. The method of claim 1, wherein the one or more edge devices are existing edge devices of the optimization target.

5. The method of claim 4, further comprising:
recommending at least two or more newly identified edge resource options from a combination of co-location and static edge sites based on user specific priorities.

6. The method of claim 5, wherein the at least two or more newly identified edge resource options are displayed to a user in a data allocation user interface, wherein the display includes improvement metrics overlayed on the display for each of the at least two or more newly identified edge resource options.

7. The method of claim 1, further comprising:
identifying a specific activity area of the optimization target based on the plurality of simulations performed using the digital twin;
reallocating at least a portion of a plurality of IoT devices of the optimization target to the specific activity area;
directing the portion of the plurality of IoT devices to perform specific sensor readings of the specific activity area; and
performing additional simulations using the digital twin and data received from the specific sensor readings.

8. A computer system for adaptive data caching, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
generating a digital twin of an optimization target based on a plurality of data, wherein at least a portion of the plurality of data is gathered by directing one or more Internet of Things (IoT) devices to perform specific sensor readings;
performing a plurality of simulations using the digital twin, wherein the plurality of simulations are utilized to predict data usage scenarios of the optimization target;
generating a plurality of caches based on the predicted data usage scenarios of the optimization target; and
deploying the plurality of caches on one or more edge devices.

9. The computer system of claim 8, further comprising:
program instructions, stored on at least one of the one or more computer-readable storage media for execution by at least one of the one or more processors via at least one of the one or more memories, to adjust cache refresh intervals for at least one or more of the plurality of caches based on a real time latency analysis.

10. The computer system of claim 8, further comprising:
program instructions, stored on at least one of the one or more computer-readable storage media for execution by at least one of the one or more processors via at least one of the one or more memories, to rank data caching priority for each of the plurality of caches based on real-time environmental and operational data.

11. The computer system of claim 8, wherein the one or more edge devices are existing edge devices of the optimization target.

12. The computer system of claim 11, further comprising:
program instructions, stored on at least one of the one or more computer-readable storage media for execution by at least one of the one or more processors via at least one of the one or more memories, to recommend at least two or more newly identified edge resource options from a combination of co-location and static edge sites based on user specific priorities.

13. The computer system of claim 12, wherein the at least two or more newly identified edge resource options are displayed to a user in a data allocation user interface, wherein the display includes improvement metrics overlayed on the display for each of the at least two or more newly identified edge resource options.

14. The computer system of claim 8, further comprising:
program instructions, stored on at least one of the one or more computer-readable storage media for execution by at least one of the one or more processors via at least one of the one or more memories, to identify a specific activity area of the optimization target based on the plurality of simulations performed using the digital twin;
program instructions, stored on at least one of the one or more computer-readable storage media for execution by at least one of the one or more processors via at least one of the one or more memories, to reallocate at least a portion of a plurality of IoT devices of the optimization target to the specific activity area;
program instructions, stored on at least one of the one or more computer-readable storage media for execution by at least one of the one or more processors via at least one of the one or more memories, to direct the portion of the plurality of IoT devices to perform specific sensor readings of the specific activity area; and
program instructions, stored on at least one of the one or more computer-readable storage media for execution by at least one of the one or more processors via at least one of the one or more memories, to perform additional simulations using the digital twin and data received from the specific sensor readings.

15. A computer program product for adaptive data caching, comprising:
one or more computer readable storage media, and program instructions collectively stored on the one or more computer readable storage media, the program instructions comprising:
generating a digital twin of an optimization target based on a plurality of data, wherein at least a portion of the plurality of data is gathered by directing one or more Internet of Things (IoT) devices to perform specific sensor readings;
performing a plurality of simulations using the digital twin, wherein the plurality of simulations are utilized to predict data usage scenarios of the optimization target;
generating a plurality of caches based on the predicted data usage scenarios of the optimization target; and
deploying the plurality of caches on one or more edge devices.

16. The computer program product of claim 15, further comprising:
program instructions, stored on at least one of the one or more computer-readable storage media, to adjust cache refresh intervals for at least one or more of the plurality of caches based on a real time latency analysis.

17. The computer program product of claim 15, further comprising:
program instructions, stored on at least one of the one or more computer-readable storage media, to rank data caching priority for each of the plurality of caches based on real-time environmental and operational data.

18. The computer program product of claim 15, wherein the one or more edge devices are existing edge devices of the optimization target.

19. The computer program product of claim 18, further comprising:
program instructions, stored on at least one of the one or more computer-readable storage media, to recommend at least two or more newly identified edge resource options from a combination of co-location and static edge sites based on user specific priorities.

20. The computer program product of claim 19, wherein the at least two or more newly identified edge resource options are displayed to a user in a data allocation user interface, wherein the display includes improvement metrics overlayed on the display for each of the at least two or more newly identified edge resource options.
